(19) United States
(12) Patent Application Publication
(10) Pub. No.: US 2025/0288073 A1
(43) Pub. Date: Sep. 18, 2025

(54) LUGGAGE SYSTEM WITH MODULAR ACCESSORIES, POWERED RECEPTACLES, AND SEALED INSERT SYSTEMS

(71) Applicant: JEFFERY BARON LESPERANCE, HOWELL, MI (US)

(72) Inventor: JEFFERY BARON LESPERANCE, HOWELL, MI (US)

(21) Appl. No.: 19/227,085

(22) Filed: Jun. 3, 2025

Related U.S. Application Data
(62) Division of application No. 17/712,337, filed on Apr. 4, 2022.

(51) Int. Cl. A45C 5/14; A45C 11/00; A45C 13/00; H02J 50/10

(52) U.S. Cl. CPC A45C 5/14; A45C 13/008; H02J 50/10; A45C 2005/142; A45C 11/001; A45C 11/002; A45C 11/003; A45C 2200/20

(57) ABSTRACT

A luggage system includes modular cavities configured to receive selectively removable inserts for holding beverage containers, mobile devices, or accessories. The inserts are formed of rubber-like elastomeric materials and employ force-fit mechanisms to secure into pre-molded cavities and create seals that prevent the ingress of liquids or debris. Some inserts include integrated wireless charging coils for powering mobile devices, electrically coupled to an internal battery or solar panel. Plug modules may replace inserts when not in use and feature sealing gaskets and latch mechanisms for protection and streamlined appearance. Standardized cavity geometry allows for interchangeable use of trays, cupholders, or electronic docks across various luggage formats, including suitcases, duffels, and backpacks. The system supports modularity, hygiene, charging functionality, and accessory expansion, transforming traditional luggage into a customizable, tech-enabled travel platform.

### CROSS-REFERENCE TO RELATED APPLICATIONS

This application is a divisional of U.S. patent application Ser. No. 17/712,337, filed Apr. 4, 2022, entitled “LUGGAGE WITH CONTAINER RECEPTACLES,” which claims priority to U.S. Provisional Application No. 63/162,648, filed Apr. 2, 2021. The contents of both prior applications are incorporated herein by reference in their entirety.

### FIELD OF THE DISCLOSURE

The present disclosure relates to luggage and mobile carrying cases, and more specifically to smart luggage incorporating modular receptacles, power supplies, device slots, trays, and selectively sealable cavities for use with personal electronic devices, beverage containers, and portable accessories.

### BACKGROUND

Conventional luggage lacks integrated support for traveler convenience during wait times in transit. Travelers commonly rest phones, cups, or meals on unstable or unhygienic surfaces due to the lack of reliable, ergonomic storage options. The invention addresses these limitations by integrating secure, optionally powered receptacles for mobile devices, beverages, and trays directly into luggage surfaces.

Prior designs also fail to accommodate flexibility in user needs, with fixed compartments that do not adapt to changing configurations or types of stored items. This disclosure introduces cavities that support swappable modules with a sealing mechanism to protect the luggage interior and improve structural utility.

### BRIEF DESCRIPTION OF THE FIGURES

The accompanying drawings, which are incorporated in and constitute a part of this specification, illustrate exemplary embodiments of the invention and, together with the detailed description, serve to explain the principles of the invention. It should be understood that the drawings are not necessarily to scale, and that various components may be shown schematically or exaggerated for clarity. Like reference numerals are used to indicate like elements throughout the several views. The embodiments illustrated are intended to exemplify, but not limit, the scope of the invention as defined in the claims.

FIG. 1A is a perspective view of a hard-sided luggage embodiment of the disclosure;

FIG. 1B is another perspective view of the embodiment of the disclosure;

FIG. 1C is a side view of a rolling duffel embodiment of the disclosure;

FIG. 1D is another perspective view of a soft-sided luggage embodiment of the disclosure;

FIG. 1E is another perspective view of a backpack embodiment of the disclosure;

FIG. 2 is another perspective view of an embodiment of the disclosure;

FIG. 3 is another perspective view of an embodiment of the disclosure;

FIG. 4 is another perspective view of an embodiment of the disclosure;

FIG. 5 is another perspective view of an embodiment of the disclosure;

FIG. 6 is an interior view of a luggage embodiment of the disclosure;

FIG. 7 is a cutaway view of a luggage embodiment of the disclosure;

FIG. 8 is another perspective view of an embodiment of the disclosure;

FIG. 9 is another perspective view of an embodiment of the disclosure;

FIG. 10 is a perspective view of a cupholder insert according to an embodiment of the disclosure;

FIG. 11 is another perspective view of the cupholder insert above a cupholder cavity of an embodiment of the disclosure; and

FIG. 12 is a cutaway view of a cupholder insert according to an embodiment of the disclosure.

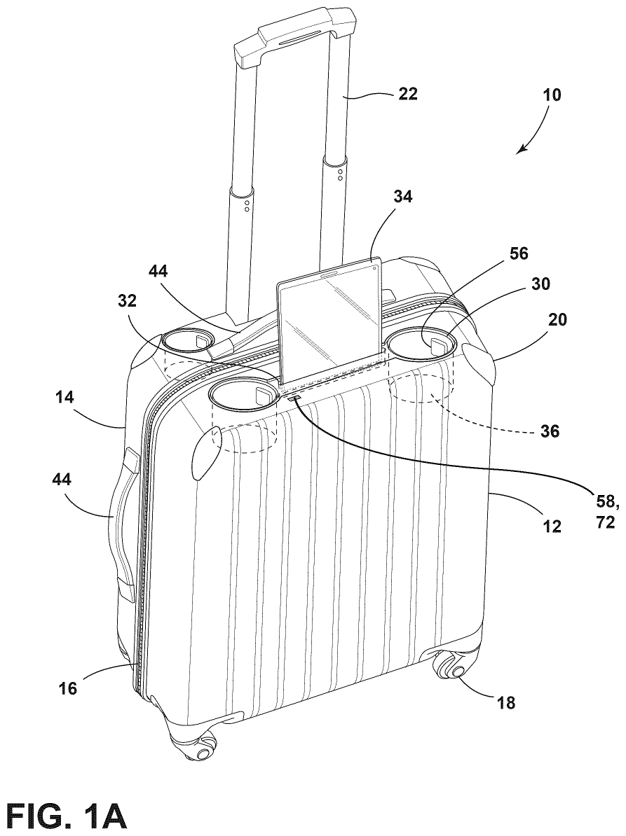

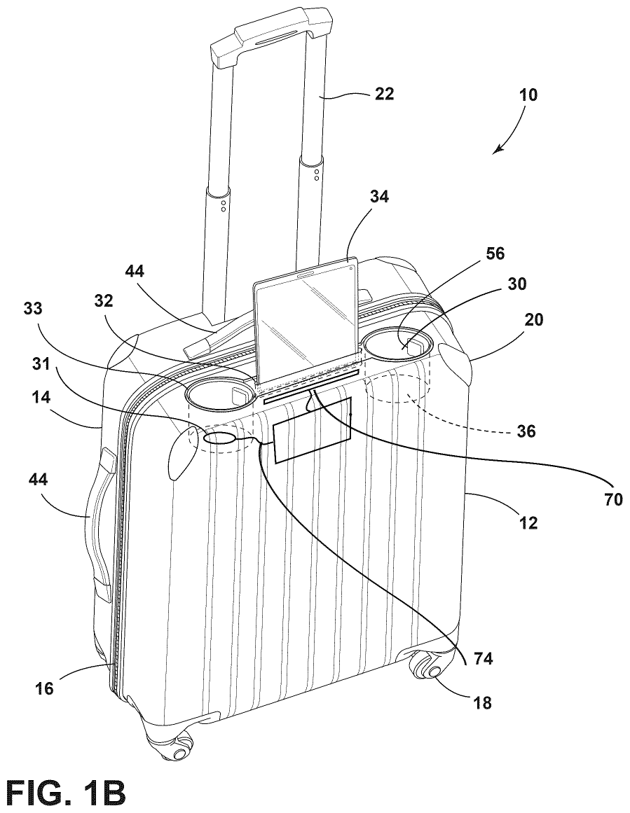

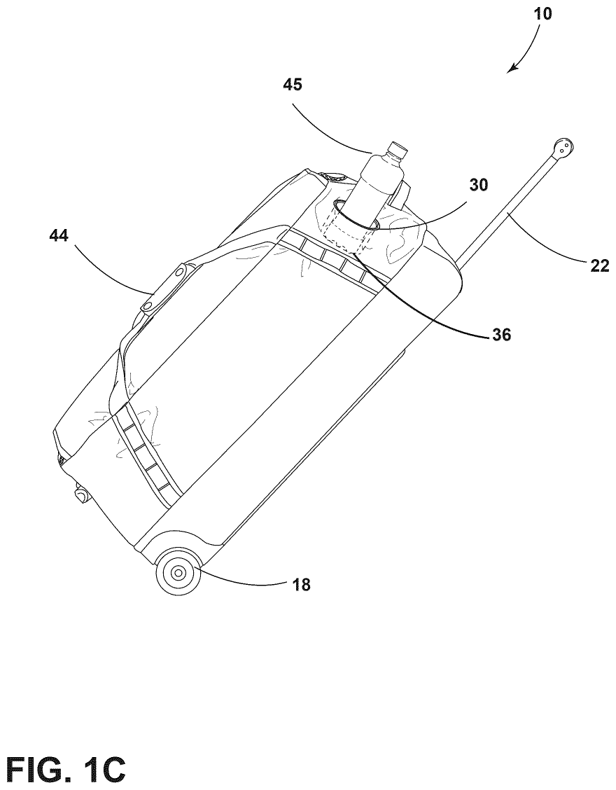

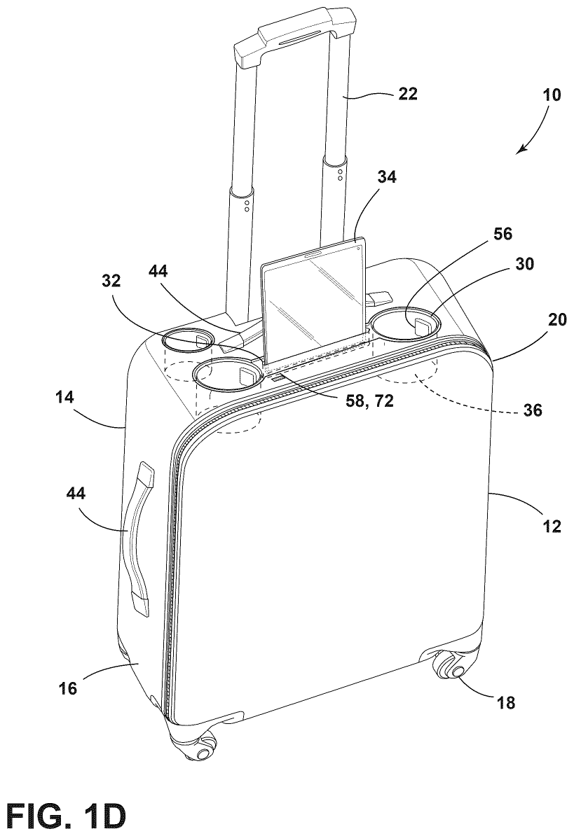

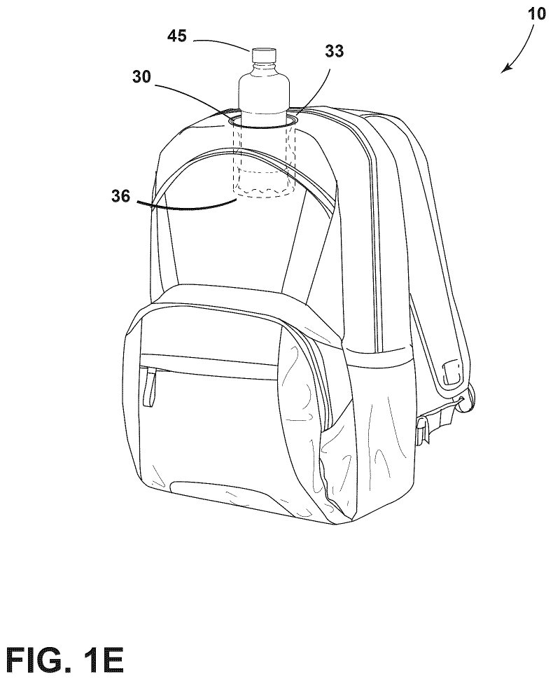

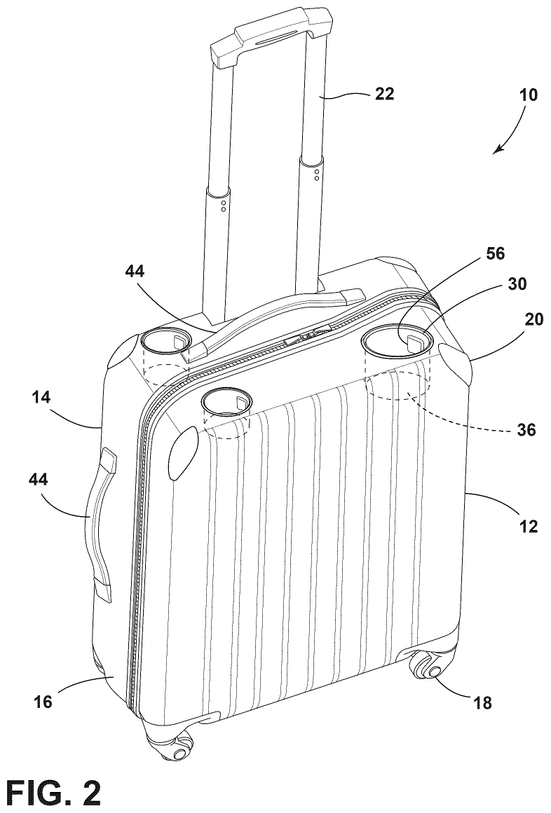

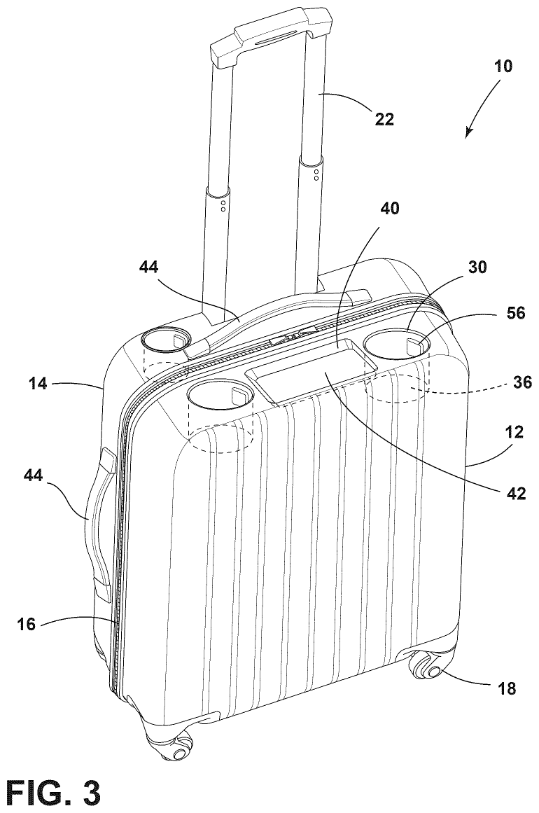

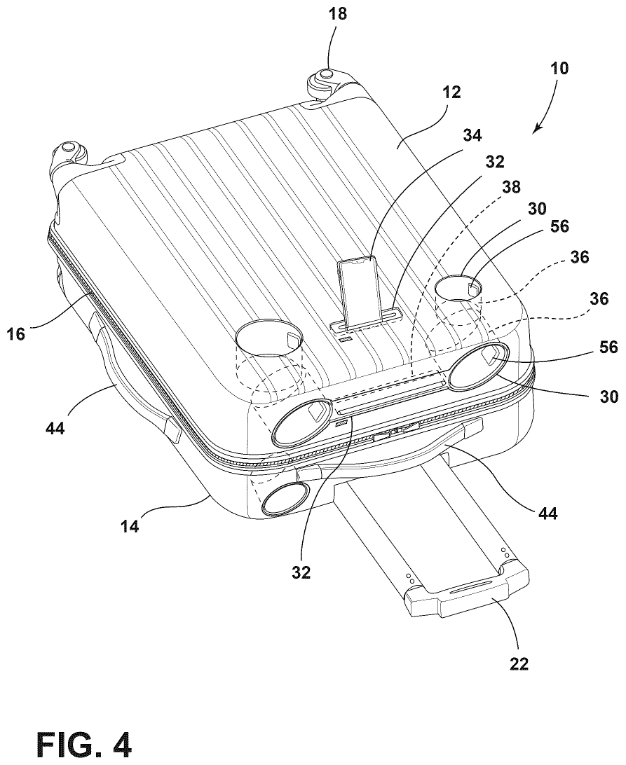

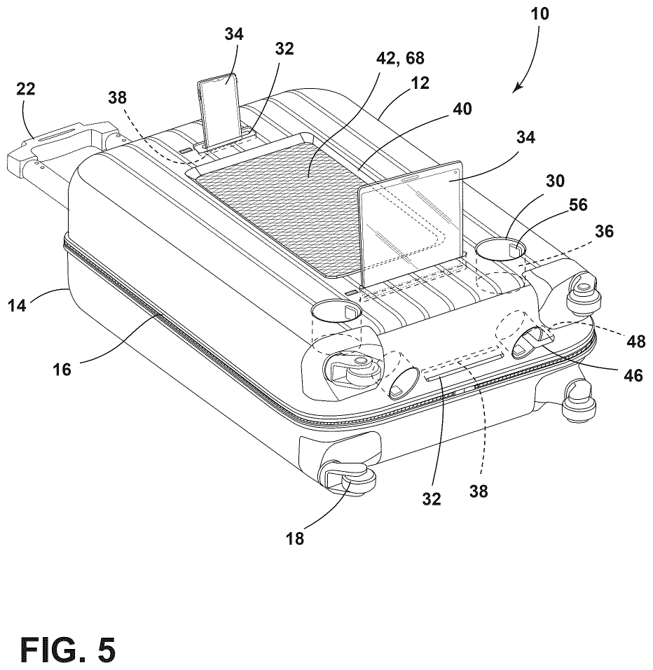

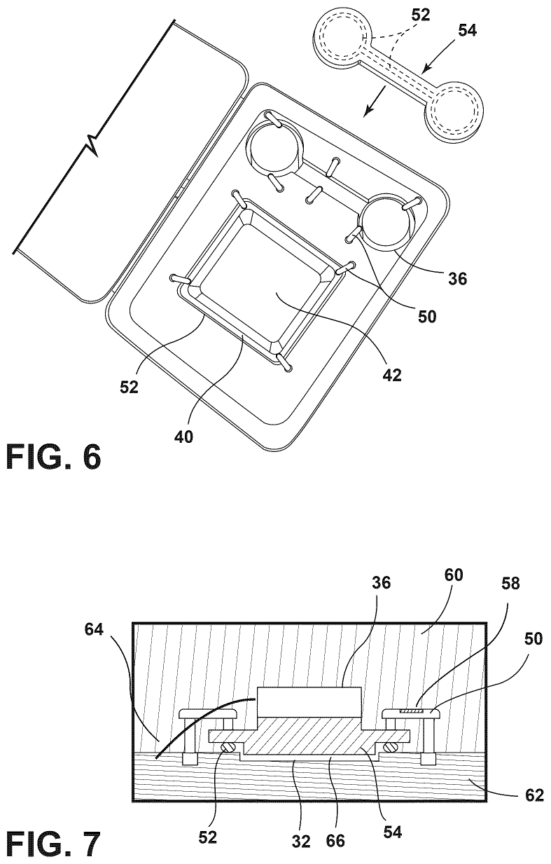

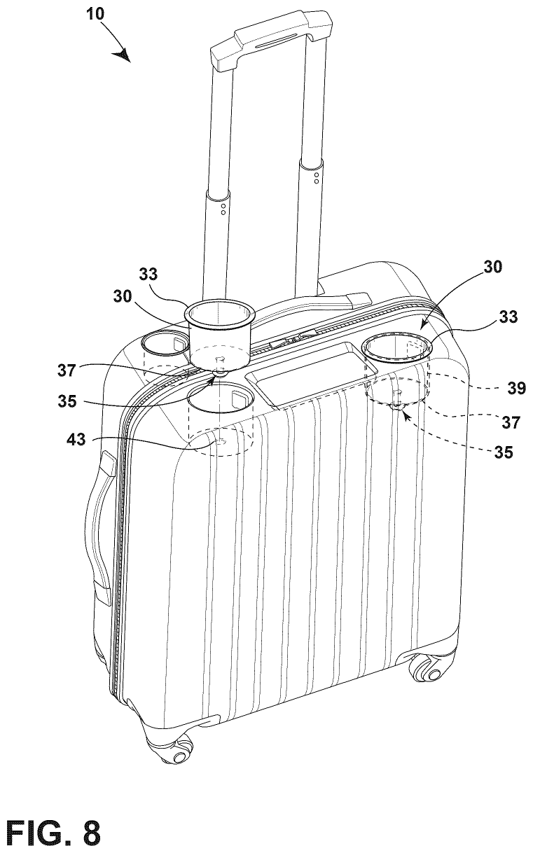

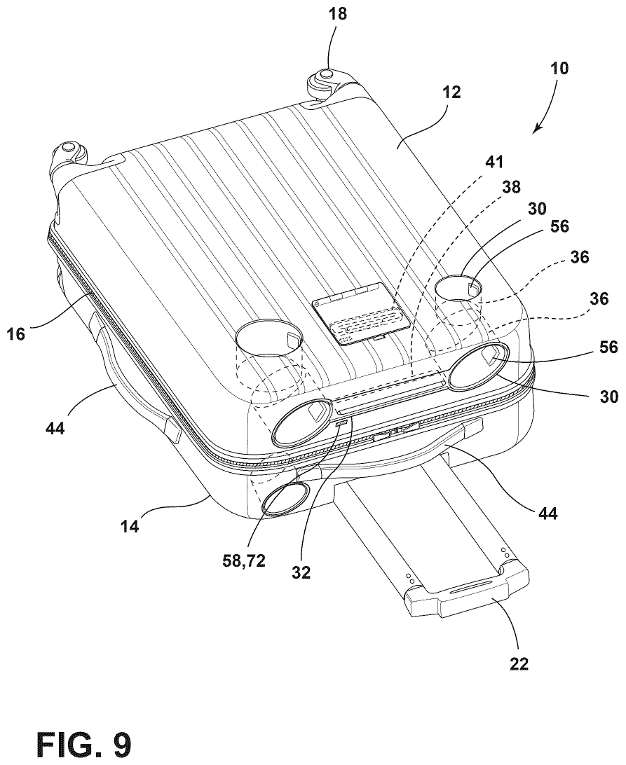

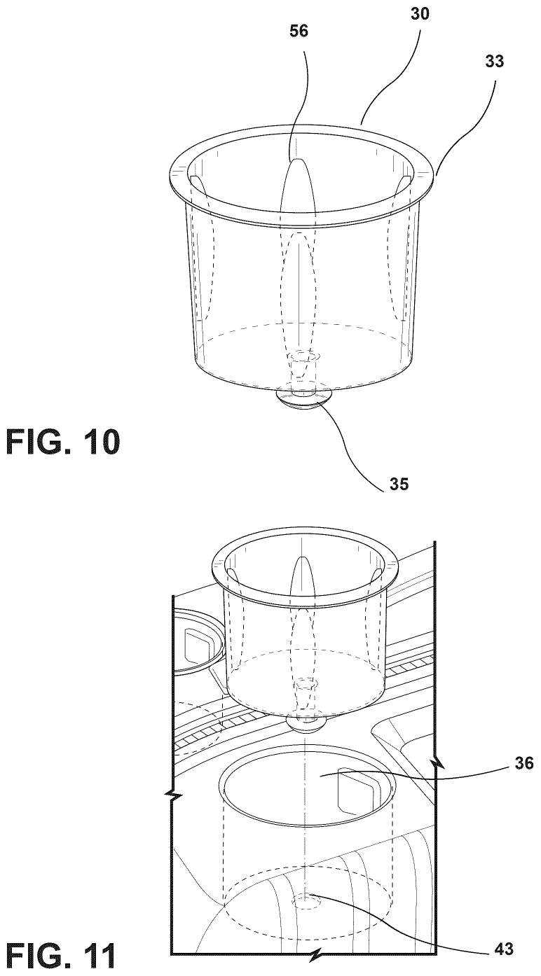

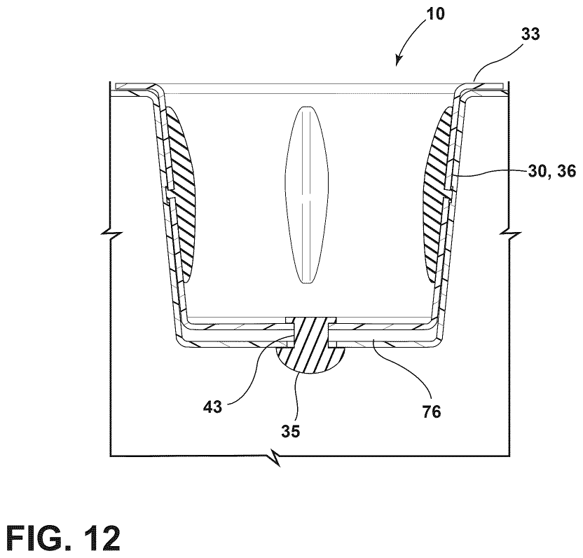

### SUMMARY OF THE DISCLOSURE

The present invention relates to a luggage system incorporating modular, selectively removable receptacles designed to accommodate beverage containers, electronic devices, and personal accessories. The system includes pre-molded cavities formed in the luggage shell and rubber-like elastomeric inserts that employ a force-fit retention mechanism to provide secure, sealed placement within these cavities. Some inserts are power-enabled, supporting wireless or wired charging through integrated coils connected to internal or solar-recharged batteries. When not in use, the cavities may be sealed with plug modules featuring gasket elements and latch mechanisms to maintain a streamlined profile and environmental protection. The modular design supports interchangeable use of tray modules, docking stations, or plugs across various luggage formats, such as hardshell suitcases, backpacks, and rolling duffels. This system enhances utility, hygiene, configurability, and electronic support for the modern traveler.

According to an embodiment of the disclosure, the luggage system may include an exterior shell, at least one cavity formed in the exterior shell, a selectively removable elastomeric insert positioned within the cavity, where the insert is formed of a rubber-like material and includes a force-fit mechanism configured to engage a corresponding feature of the cavity to retain the insert in position and form a seal against ingress of contaminants.

According to an embodiment of the disclosure, the luggage system may include a cavity that is shaped to receive a beverage container, and the elastomeric insert includes internal ribs or a flexible flange configured to stabilize the beverage container.

According to an embodiment of the disclosure, the luggage system may include a cavity that is shaped to receive a mobile electronic device, and the insert comprises an embedded wireless charging coil electrically coupled to a power supply within the luggage.

According to an embodiment of the disclosure, the luggage system may include a transparent or hinged cover configured to protect the mobile electronic device while allowing viewing of the screen.

According to an embodiment of the disclosure, the luggage system may include a force-fit mechanism that comprises compressible lobes, ridges, or tabs that deform into corresponding holes or grooves formed in the cavity wall.

According to an embodiment of the disclosure, the luggage system may include a removable plug module configured to seal the cavity when the insert is not in use.

According to an embodiment of the disclosure, the luggage system may include a plug module that includes a compressive gasket and a latching mechanism selected from a twist-lock, snap-fit, or magnetic latch.

According to an embodiment of the disclosure, the luggage system may include a plug module that includes a visual indicator to confirm proper sealing.

According to an embodiment of the disclosure, the luggage system may include an exterior shell, a mobile device slot formed in the shell, a Qi-compatible wireless charging coil embedded in the slot, a rechargeable battery disposed within the shell and electrically coupled to the charging coil, where the slot includes an elastomeric lining and a cover configured to protect a device during transport.

According to an embodiment of the disclosure, the luggage system may include a cover that is transparent and hinged or magnetically attached.

According to an embodiment of the disclosure, the luggage system may include an LED indicator that provides charging status.

According to an embodiment of the disclosure, the luggage system may include a slot that includes alignment guides or detents for positioning the mobile device.

According to an embodiment of the disclosure, the luggage system may include a solar panel mounted on the exterior shell, electrically coupled to the rechargeable battery.

According to an embodiment of the disclosure, the luggage system may include a set of standardized cavities formed in an exterior shell, a plurality of interchangeable plug modules configured to mate with the standardized cavities, each plug module including a sealing element and a latching mechanism, where the plug modules differ in geometry or function and are replaceable across different luggage formats.

According to an embodiment of the disclosure, the luggage system may include at least one plug module that includes an RFID tag or embedded sensor for tracking or verification.

According to an embodiment of the disclosure, the luggage system may include a latching mechanism that includes a twist-lock, snap-fit, or magnetic fastener.

According to an embodiment of the disclosure, the luggage system may include a plug module that includes a drainage seal or environmental barrier.

According to an embodiment of the disclosure, the luggage system may include a plug module that is removable without tools via a molded grip or tab.

According to an embodiment of the disclosure, the luggage system may include at least one standardized cavity that includes a recessed tray for food or electronics and an embedded charging interface.

According to an embodiment of the disclosure, the luggage system may include accessory kits containing plug modules and cavity inserts for user customization.

### DETAILED DESCRIPTION

The following description is provided to enable any person skilled in the art to make and use the invention and sets forth the best modes contemplated by the inventor for carrying out the invention. Various modifications, however, will remain readily apparent to those skilled in the art, since the general principles of the present disclosure have been defined herein to provide: a luggage system with modular accessory integration, including force-fit inserts, charging elements, and standardized cavity geometry.

While the invention is described below in connection with certain illustrative embodiments, it will be understood that these embodiments are not intended to be limiting. On the contrary, the invention is intended to cover alternatives, modifications, and equivalents as may be included within the scope and spirit of the claims.

According to the present disclosure, the luggage 10 may include selectively removable and/or integrated receptacles 30 designed to hold beverage containers 45 and/or electronic mobile devices 34.

It should be understood that the term “luggage” as used herein is intended to be construed broadly to encompass any article or device used to carry cargo or personal belongings, including but not limited to traditional and non-traditional forms. Examples illustrated herein-such as a hard-sided rolling suitcase, soft-sided rolling luggage, backpack, or rolling duffel-are representative and not limiting. The term further includes luggage that may be carried, wheeled, worn, dragged, or otherwise transported, and may be constructed from any suitable material. It should be understood that references to “luggage” herein are intended to include both currently available and later-developed forms of portable cargo containers.

These receptacles 30 are incorporated into exterior surfaces 12, 14 of luggage 10 and provide users with immediate, ergonomic access to key items during transit and while stationary. By positioning these features along accessible portions of a suitcase or bag 10, such as the top panel or side wall of front portion 12, rear portion 12, the luggage 10 supports a more functional and comfortable user experience, particularly while seated in waiting areas or standing in lines. Wheels 18 may be positioned about luggage 10 for ease of movement.

The receptacles or inserts 30 (may be configured as cupholders, slots, or trays, for example) may be either permanently molded into the luggage body or configured as modular inserts. In one embodiment, an elastomeric cupholder insert 30 is fitted into a pre-molded cavity 36. This insert 30 is fabricated from a rubber-like material such as silicone or thermoplastic elastomer and features a force-fit retention mechanism 35. The force-fit design allows the insert 30 to engage one or more holes or ports 43 in the cavity wall or floor, providing both mechanical stability and a sealed interface to prevent ingress of liquids or debris into the interior of the luggage 10.

This elastomeric insert 30 configuration offers multiple benefits. First, it provides a high-friction interior surface capable of stabilizing a beverage container 45 under dynamic travel conditions. Second, the material deforms elastically under load, accommodating a variety of diameters of container 45 while maintaining a secure grip. Third, the insert 30 is removable and washable, improving hygiene and enabling customization by the user. If the user prefers not to use the cavity 36, a blank plug 54 with a sealing gasket 52 can be inserted instead. Fourth, the insert 30 may include one or more engaging devices or grips 54 to selectively engage an item placed into the insert 30 (e.g., a mobile device 34, a beverage container 45, etc.).

In an alternative embodiment, the luggage 10 includes a slot-shaped receptacle 32 configured to receive a mobile phone, tablet, or other handheld electronic device 34. This slot 32 may be integrated directly into the shell of the luggage 10 or implemented as a removable module, similar to the cupholder insert 30. Within the slot 32, a wireless charging coil/power system 31 and associated power electronics are embedded, allowing the user to charge their mobile device 34 while it remains visible and accessible.

The cupholder receptacles 30 are further distinguished by their ability to be sealed. Each cavity 36 may include a plug element 54 made from molded plastic or flexible elastomer, featuring one or more sealing elements 52 such as O-rings, ridges, or lips. These plugs 54 are designed to mate with the receptacle's inner surfaces 37 and include mechanical latching feature(s) 35 that can be engaged via twist-lock, snap-fit, press-fit, or magnetic retention, for example. The result is a low-profile exterior that maintains the luggage's streamlined design when the receptacle 30 is not in use.

To accommodate power delivery, a wired or wireless (contactless) charging device 31 includes internal wiring that connects the receptacles 30 to the rechargeable battery or other power source of charging device 31 stored within the luggage 10. This allows powered receptacles to support both wired and wireless charging applications. The internal architecture of luggage 10 may include strain-relief grommets and waterproof seals around wire pass-throughs/ports 70, ensuring that the system 31 remains safe and reliable even during rugged travel.

In addition to beverage and electronic receptacles 30, the present disclosure contemplates hybrid modules that combine both functions in a single accessory bay. For example, a tray 40 may be configured to include both a drink holder and a phone dock. Tray 40 may be installed on the top surface of the luggage 10, enabling tray 40 to act as a mini-desk or workstation for the user. Each functional zone within the tray 40 may be independently removable or replaceable, allowing the user to configure the luggage 10 according to their specific usage or routine.

Another advantage of the selectively removable insert 30 system is its compatibility with a wide range of types of luggage 10. The cavities and inserts 30 can be incorporated into hardshell and softshell suitcases, rolling duffels, backpacks, and specialty gear bags, among a wide variety of containers as detailed herein. This enables the technology to serve multiple markets including business travel, leisure, emergency response, and sporting equipment. For example, a hockey bag may include integrated receptacles 30 for water bottles and phones 34 used by athletes or coaches.

During manufacture, the receptacle systems 30 may be integrated using injection-molding, post-formed installation, or modular assembly techniques. Each cavity or recessed portion 36 of luggage 10 is designed to align with standardized insert profiles, enabling the use of universal or interchangeable accessories. A user could carry multiple insert types-such as one for beverages 45 and another for electronics 34—and swap them into the same cavity 36, depending on the day's needs.

Finally, this receptacle system 30 supports accessory expansion without the need to redesign the core of the luggage 10. Future enhancements might include thermally insulated beverage modules, enhanced device holders with cooling vents, or receptacles with smart sensors/lights/indicators 58 for battery level or environmental conditions, for example, and without limitation (in some embodiments, sensors/lights/indicators 58 may be co-located with switch 70). By establishing a robust and versatile receptacle architecture, the receptacle system 30 of luggage 10 lays the groundwork for the next generation of intelligent, traveler-responsive luggage systems.

In another embodiment, the luggage 10 of the present disclosure may include plug modules 54 specifically designed to seal unused receptacle openings 36. These plugs 54 provide at least a dual function: the plugs 54 preserve the streamlined appearance and structural integrity of the luggage 10 and prevent the ingress of water, dust, and debris into the cavity 36. This feature is particularly important in applications where the luggage 10 may be exposed to unpredictable weather conditions or rough handling during transport, for example.

The plugs 54 are shaped to correspond to the geometry of the receptacle cavities 36 and include one or more sealing components, such as compressive gaskets or O-rings 52. These form a barrier between the plug 54 and the cavity wall/cupholder bottom 37, enabling a water-resistant or even potentially an airtight seal. This protective measure ensures that internal compartments of luggage 10 remain clean and dry, which is particularly valuable when electronics, food, or documents are carried within the luggage 10.

Each plug 54 is equipped with a latching mechanism 50 designed to secure the plug 54 in place under dynamic conditions, including vibration, jostling, or sudden impact, for example. In one embodiment, a twist-lock latch 50 is used; in another, a push-and-click detent system holds the plug 54 firmly in position. Alternative designs may employ magnetic retention paired with a mechanical release for ease of use. These latches 50 are integrated into the perimeter of the plug 54 and engage corresponding structures built into the walls of cavity 36.

To aid assembly and disassembly, plugs 54 may feature finger grips, tabs, or recessed notches that allow the user to insert or remove them without the need for tools. This facilitates rapid conversion of the cavity 36 from sealed to open use and vice versa, enhancing the luggage 10 adaptability to changing travel needs. In some cases, the plug 54 may be tethered to the luggage 10 by a flexible strap, clip, or tether 64 to prevent loss.

Plugs 54 are particularly useful for users, including travelers, who prefer not to carry mobile devices 34 or beverages 45 externally. By sealing these cavities 36, the user can maintain a clean and cohesive luggage profile, which may be preferred for professional settings or for maximizing stowage efficiency in overhead compartments. The plugs 54 also prevent foreign objects from inadvertently entering the cavity 36.

The materials used in plug 54 construction may include molded plastics, reinforced polymers, or thermoplastic elastomers. The outer surface of the plug 54 may be textured, color-matched, or branded to match the luggage 10. Internally, the plug 54 may include embedded magnets or reinforcing ribs 66 to provide rigidity and secure latching performance.

In advanced embodiments, the plug 54 may include embedded sensors or indicators 58 that confirm successful latching, sealing, or other information to the user. For example, a plug 54 may illuminate an LED 58 when fully seated and latched, signaling to the user that the luggage 10 is ready for use. Other plugs 54 may include RFID tags 58 to interface with luggage tracking systems or to restrict access to certain cavities unless verified by a paired device.

Plugs 54 may be manufactured in multiple sizes and profiles to support a range of cavity geometries, including circular cupholder shapes, rectangular slots for devices, and hybrid tray recesses. A single luggage article 10 may include several plug 54 types, each specifically designed to mate with its corresponding cavity 36. This modular architecture supports both user customization and future accessory expansion.

To ensure compatibility, plug 54 designs may be standardized across the product line. This allows the same plug 54 to be used in multiple models of luggage, backpacks, and equipment cases 10. Retail accessory kits may be offered that include replacement plugs 54, colored or custom plugs 54, and plugs 54 with logo embossing, for example and without limitation.

Finally, by combining plugs 54 with gasket seals 52 and latch mechanisms 50, the luggage 10 provides a solution to protecting multi-use cavities 36 when not in service. This solution enhances the functional lifespan, appearance, and user satisfaction associated with luggage 10 according to the present disclosure.

In another embodiment, the luggage 10 may include receptacles 36 and tray modules 40 equipped with integrated power functionality 31. These features are designed to accommodate the increasing reliance of users on electronic devices 34 by enabling charging directly from the luggage 10. Wireless and wired charging capabilities 31 can be embedded into mobile-device slots, cupholder bases, or recessed trays 30, 32, 40, and notch 46. For example, notch 46 may extend from cupholder 30 and include notch recessed portion 48 to receive a beverage container with a hand grip (e.g., a coffee mug).

In one embodiment, a recessed mobile device slot 32 includes a Qi-compatible wireless (or wired) charging (coil) system 31 positioned beneath a rubberized insert 30. The insert 30 holds the mobile device 34 securely in place, and electrical connections of the wireless charging coil system 31 within the luggage 10 route power from an internal battery or external solar panel to the coil of the wireless charging coil system 31. This configuration allows a user to drop their phone 34 into the slot 32 and charge it passively while seated or in transit, for example. The battery of the wireless (or wired) charging system 31 may be selectively removable to accommodate travel restrictions, for example.

In another configuration, a power-enabled tray 40 is located on the top surface or front, rear portions 12, 14 of the luggage 10. The tray 40 may include a molded flat zone (or sunken/depressed portion) 42 for holding food or electronics and one or more embedded charging components 31. A wired USB-C or Lightning port 31 may be built into a corner of the tray 40, while a wireless charging pad 31 may also be embedded centrally, all connected to the internal power source 31. This design transforms the luggage 10 into a functional mobile workstation or dining platform, for example. Tray 40 may include a tray cover 41.

To provide power, the system 31 includes a rechargeable power supply integrated into the interior shell of the luggage 10. The power unit may consist of a lithium-ion (for example) battery pack, optionally connected to optional photovoltaic solar panels 68. In some embodiments, a port 70 for AC charging using system 31 may be provided to replenish the power bank of system 31.

The charging circuits of the wired or wireless charging system 31 may be housed within sealed channels in the luggage 10 to prevent exposure to moisture or mechanical stress. Wiring 74 may be routed through strain-relief grommets, and waterproof enclosures are used to isolate charging hardware in luggage 10. These measures ensure both safety and durability in rugged travel conditions.

The user interface for the charging components 34 may include LED indicators 58 near each receptacle or tray to show charging status, power availability, faults, or other information. A power switch 72 may also be accessible from outside the luggage 10, allowing the traveler to enable or disable the charging system 31 as needed for security or energy conservation. In embodiments, power switch 72 may be combined with sensor/light/speaker 58.

An additional advantage of the power-enabled system 31 is its modularity. A user may choose to insert a tray 40 with power features or replace it with a simple storage insert or blank plug 54 when not needed. Each module connects to the power bus of the charging system 31 via “pogo” pins or magnetic contacts, for example, and without limitation, that automatically engage when the module 30, 32, 40 is inserted into the cavity 36.

The charging-enabled modules 30, 32, and 40 are suitable for various types of luggage 10, including hardshell carry-ons, rolling duffels, and backpacks. In one embodiment, luggage 10 may include a solar array 68 which charges the internal battery of charging system 31 powering mounted modules 30, 32, and 40.

To increase the product lifespan, components such as wireless charging pads or USB ports of charging system 31 are designed to be field-replaceable. The cupholder receptacle 30, slot 32, tray 40 module can be detached, and a new charging element can be swapped in without disassembling the luggage 10. This modular design supports after-market upgrades or warranty replacements.

Ultimately, these power-enabled receptacles, slots, and trays 30, 32, and 40 transform the luggage 10 from a passive storage item into an active travel tool. Whether holding a coffee cup, recharging a phone, or acting as a tray table, the integration of smart power features supports a higher level of comfort, efficiency, and convenience for today's tech-enabled travelers.

An embodiment of the luggage 10 may include elastomeric inserts 30, 32, and 40 may be fabricated from rubber-like materials, which serve as the primary interface between the traveler's items and the receptacle cavities 36. These inserts 30, 32, and 40 are positioned within pre-molded cavities 36 located on the external or internal surfaces 12, 14, 60, 62 of the luggage 10, and they provide both frictional grip and hygienic separation between the luggage 10 and stored objects such as electronic devices 34 or beverage containers 45, among other possible items.

The elastomeric material may be a thermoplastic elastomer (TPE), silicone rubber, EPDM, or a similar compound that is both durable and flexible. The material properties are selected to ensure adequate friction to retain items in place, especially during movement or vibration. This is particularly important in travel environments where luggage 10 is subjected to rolling, lifting, or stowing forces.

The inserts 30, 32, and 40 are designed to be selectively removable. Each insert may be installed by a simple push-fit or force-fit mechanism 35 that allows it to be seated securely within a mating cavity 36 of luggage 10. One or more projections or retaining tabs 35 on the insert may engage holes, ports, or grooves 43 in the cavity wall. This engagement ensures that the insert stays in place during use, but can be easily removed by hand for cleaning, replacement, or reconfiguration.

To improve user convenience, the elastomeric inserts may be shaped with finger grips, textured sidewalls, or tab extensions that facilitate removal. The interior surface 37 of each insert may be contoured or ribbed to improve grip on cylindrical beverage containers or rectangular electronic devices. In some embodiments, the insert includes spring-loaded features or nested lips 54 that enhance the fit for variable-sized objects.

The hygiene benefit of elastomeric inserts is substantial. Travelers and other users frequently consume food or beverages 45 on the go, and mobile devices 34 are often touched throughout the day. A removable insert 30, 32, and 40 made of rubber-like material allows for simple cleaning with soap and water or disinfectant wipes. This helps prevent the buildup of bacteria, dirt, or spills, which is a common drawback in traditional luggage that lacks washable components.

In a cupholder application, the elastomeric insert 30 may include an annular (for example) cavity 36 or inner flange that receives the base of a coffee cup, water bottle, or travel mug 45. Because of its flexibility, the insert 30 can accommodate slight variations in container size while maintaining a snug and stable fit. The elastomeric nature of the insert 30 also dampens noise and vibration during transit. Cupholder 30 may include a cupholder rim 33, a cupholder retaining device 35, a cupholder recessed portion 36, a cupholder bottom 37, a slot recessed portion 38, and a cupholder wall 39.

The inserts (cupholder, slot, and tray) 30, 32, and 40 are designed to integrate seamlessly with other modular elements of the luggage 10, such as power-enabled (via charging system 31) receptacles or sealed plug modules 54. For instance, a user may remove an elastomeric beverage insert 30 and replace it with a charging module-capable insert 30, 32, or 40, or a blank sealing plug 54, depending on the current use case. This flexibility enhances the luggage 10 adaptability without requiring structural modifications.

To ensure compatibility across different luggage models and insert types, the elastomeric components 30, 32, and 40 may follow a standardized profile. This allows for interoperability and supports after-market upgrades. For example, a traveler could purchase different color-coded or specialty-function inserts 30, 32, and 40 and install them into any compatible cavity on their luggage 10, for customization or wear replacement, for example.

The external surfaces of the inserts 30, 32, and 40 may include design features such as molded branding (i.e., logos), color-coded indicators, or even integrated QR codes for accessing product information or maintenance instructions. These cosmetic and functional enhancements add to the perceived value and user experience of the luggage 10.

Altogether, the use of elastomeric inserts 30, 32, and 40 made from rubber-like materials contributes significantly to the comfort, usability, and cleanliness of the luggage 10. Their modularity and tactile advantages make them ideal for travelers who demand both functionality and convenience from their luggage 10.

An embodiment of the luggage 10 may include one or more rubber-like cupholder inserts 30 that utilizes a force-fit mechanism 35 to enhance both performance and ease of assembly. This insert 30 is configured to be received within a pre-molded cavity 36 in the luggage 10, such as the front or side panel 12, 14, 60, 62 of a suitcase or duffel, for example and without limitation. This configuration addresses multiple objectives: secure beverage storage, environmental sealing, and simple user interaction.

The cupholder insert 30 may be constructed from an elastomeric material, such as silicone rubber or thermoplastic elastomer (TPE), selected for its durability, flexibility, and resistance to water, heat, and cleaning agents. The material composition ensures that the insert conforms slightly to the shape of the cavity 36 and beverage container 45, enhancing the frictional engagement and minimizing rattle or instability during movement.

Integral to the insert 30, 32, and 40 function is its force-fit engagement system. The outer perimeter of the insert includes one or more protruding tabs, ridges, or compressible lobes 35 designed to align with corresponding holes or detents 43 formed in the cavity 36. When the insert is pressed into the cavity, these features deform slightly and then snap or wedge into place, holding the insert securely without additional fasteners.

The force-fit design offers several advantages. First, it enables tool-free installation and removal, allowing users to quickly insert or remove the cupholder 30 (or slot 32 or tray 40) module for cleaning or reconfiguration. Second, it allows for precise positioning and alignment, ensuring that the insert remains stable and flush with the surface cavity 36. Third, it avoids the need for adhesives, screws, or other hardware, reducing manufacturing complexity and cost.

Another key function of the cupholder insert 30 (as well as slot 32 and tray 40) is to seal one or more ports 43 located within the cavity 36. These ports 43 may be necessary for mold release, fluid drainage, or integration with other accessories. The rubber-like material deforms around these openings, and in some embodiments includes molded sealing plugs or lips that directly cover or fill the ports 43. This sealing capability helps protect the interior of the luggage 10 from accidental spills or external moisture.

The cupholder insert 30 may be shaped to accommodate standard beverage containers, such as water bottles, disposable cups, or insulated tumblers. The internal surface may be smooth or textured and can include concentric ribs, soft grips, or angled walls that adapt to different container diameters. These features combine to create a secure cradle that prevents tipping or movement during travel.

To facilitate removal, the insert may include a molded tab or recessed grip zone accessible from the top edge. This allows the user to easily pinch or lift the insert without damaging the surrounding cavity or deforming the structure. The material is resilient enough to withstand repeated insertion and removal cycles without fatigue or tearing.

The insert is compatible with both powered and non-powered cupholder modules. In powered versions, the cavity may include a heating or wireless charging element below the insert. The rubber-like material may include a central aperture or window to enable heat transfer or allow inductive energy flow to a device such as a mug warmer or phone resting atop the cupholder.

Importantly, the insert's modular nature allows for interchangeability with other cavity accessories. A user may remove the rubber-like insert and install a plug module, tray insert, or electronics dock in its place. All components conform to the same basic cavity geometry and force-fit engagement strategy, promoting convenience and long-term flexibility.

Overall, the rubber-like cupholder insert with force-fit retention represents a thoughtful integration of mechanical, ergonomic, and material design principles. It contributes to the overall functionality of the smart luggage system by enabling reliable beverage storage, environmental sealing, and ease of use in a compact, traveler-friendly format.

An embodiment of the luggage may include one or more mobile-device receiving slots, which provide both physical support and electrical charging capabilities for smartphones, tablets, and other portable electronics. These slots are formed into the outer surfaces of the luggage and are designed to secure a user's device during layovers, in-transit moments, or periods of active use in travel environments.

The slots may be oriented vertically or horizontally, and positioned in easily accessible locations on the luggage, such as the top panel, front face, or sidewall, for example, near the handles 22, 44. Each slot is dimensioned to receive a standard smartphone or similar device, with enough tolerance to accommodate various brands and protective cases. The interior of the slot may be lined with a rubber-like insert or frictional pads to prevent scratches and ensure a stable fit.

In a preferred embodiment, the base of the device slot houses a Qi-compatible wireless charging coil. The coil is embedded within or beneath the slot's surface and is electrically coupled to a power supply module located within the luggage shell. This setup enables the user to charge their phone simply by placing it into the slot, without requiring a USB cable or adapter. The system conforms to established Qi wireless charging standards, allowing compatibility with a wide range of devices. The charging slot may be optionally covered with a hinged or removable lid. In other embodiments, a soft cover or magnetic flap may be used to conceal the slot when not in use, preserving the aesthetic of the luggage and preventing accidental activation.

To enhance usability, the interior of the slot may feature an alignment guide, visual indicator, or soft detent that helps position the device directly over the charging coil. In more advanced configurations, a sensor or feedback LED may confirm that the device is properly aligned and charging. These indicators may be located adjacent to the slot or incorporated into the power control panel of the luggage.

Power for the charging coil is provided by a rechargeable battery stored within the luggage or, optionally, by a solar panel mounted on the outer shell. The internal circuitry includes voltage regulation and safety features such as over-temperature protection, short-circuit prevention, and automatic shutoff once the device is fully charged. Some versions may also offer pass-through charging that allows the internal battery and device to charge simultaneously.

The slot itself may be molded as part of the luggage body or added as a modular component. Modular slots are advantageous because they can be replaced or upgraded independently of the main structure. This allows the traveler to adapt their luggage for new device sizes or charging technologies in the future. Each modular slot unit connects via concealed electrical terminals and may be locked in place using integrated tabs or clips.

In terms of hygiene and durability, the slot is designed to be water-resistant and easy to clean. The interior surfaces may include antimicrobial coatings or be fabricated from non-porous materials. Drainage channels or raised ridges may be included to prevent liquid accumulation within the slot cavity.

Some embodiments provide multi-function slots that can accept either a mobile device or a plug-style accessory, depending on the user's needs. For example, the slot may double as a badge holder, travel document pocket, or RFID tag reader. This flexibility enhances the utility of the luggage while minimizing added weight or bulk.

Altogether, the mobile-device slot with optional cover and integrated Qi-compatible charging coil addresses a common pain point for modern travelers: maintaining device accessibility and battery life on the go. This feature transforms passive luggage into an active travel companion, bridging the gap between utility, safety, and modern connectivity needs.

An embodiment of the luggage may include one or more reinforcement elements that enhance the durability, modularity, and cross-platform compatibility of the smart luggage system. These elements, including bumpers 20, trays 40, and structural cavities 30, 32, and 40, are implemented across a wide range of luggage formats to accommodate diverse use cases, from casual travel to professional and emergency deployments.

Bumpers 20 are positioned at high-wear areas such as corners, edges, or the base of the luggage 10, where impacts and abrasions are most likely. These may be constructed from thermoplastic rubber, hard polyurethane, or other resilient materials. In addition to protecting the shell of luggage 10 from damage, bumpers 20 serve a secondary function as anchoring zones for modular accessories, providing molded-in rails, notches, or screw points to receive trays 40 or power modules 31.

Trays 40 serve both as reinforcement and utility surfaces. In one embodiment, a top-mounted tray 40 is recessed into the luggage 10 and framed by a raised lip to prevent spillage. The tray 40 may be fabricated from injection-molded plastic or co-molded with soft elastomeric pads to provide both rigidity and grip. These trays 40 can be used for staging electronic devices 34, food, or personal items, and in some configurations, include embedded power ports or wireless charging pads 31.

Structural cavities, pre-molded into the body of luggage 10, are engineered to receive a wide variety of inserts and accessories. Their consistent geometry allows for interchangeability of modules such as cupholders 30, phone slots 32, and trays 40. Each cavity 30, 32, and 40 may be reinforced with ribbing or flanges 66 to resist deformation under load, ensuring long-term integrity despite frequent insert swapping or external pressure.

Importantly, the reinforcement architecture has been designed for adaptability across multiple luggage configurations. Hardshell suitcases benefit from molded-in reinforcement zones within the polycarbonate or ABS structure, while softshell and duffel bags use rigid or semi-rigid frames embedded within the fabric layers. In either format, the cavities 30, 32, and 40, and bumpers 20 are integrated without compromising overall aesthetics or weight requirements.

Backpacks and emergency responder bags 10 may incorporate side- or top-access cavities supported by underlying plate reinforcements. These plates distribute forces across the softshell material, ensuring that the structural openings retain their shape and usability. Bumpers 20 (i.e., corner guards) are also used on these bags 10 to support ground contact and improve abrasion resistance during rapid deployment or field use.

The modular nature of the reinforcement elements allows for the development of standardized accessory kits. For example, a single tray design 40 can be used across a duffel, a roller bag, and a backpack, thanks to consistent mounting points and compatible cavity shapes. This standardization lowers production costs, simplifies user customization, and supports the sale of aftermarket components.

The tray and cavity reinforcements also enhance functional rigidity for specific tasks. A recessed tray on a hardshell suitcase 10 can double as a writing surface or staging platform, supported by a perimeter rib 66. A structural cavity 30, 32, and 40 with bumpers 20 may host fragile equipment or food items without collapsing, making the luggage 10 more than just a container—it becomes a mobile workstation or operations base.

Environmental sealing is maintained around reinforced elements using over-molded gaskets 52 and/or plug-compatible lids 54. This ensures that the structural additions do not compromise the water resistance or cleanliness of the luggage interior. In responder gear applications, for example, this sealing helps keep dust, debris, and biological contaminants away from mission-critical equipment.

In total, the incorporation of reinforcement elements like bumpers, trays, and cavities serves as a foundational enhancement to the luggage platform. These elements support not only structural strength and product longevity, but also enable the modular integration of power-enabled and hygienic inserts, positioning the luggage system 10 as a flexible and future-ready travel solution.

The luggage 10 of the present disclosure may include one or more of the following elements. A front portion 12 and a rear portion 14 that together define an enclosed interior volume for the containment of personal items. These portions 12 and 14 may be hingedly or removably joined using zippers, latches, or clamshell-style couplings 16. The separation allows for full access to the interior and facilitates efficient packing and unpacking.

One or both portions 12, 14 of the luggage 10 may include pre-molded cavities 30, 32, and 40 configured to receive modular insertable cupholders 30, slots 32, and trays 40. These cavities 30, 32, and 40 are precisely dimensioned to host a variety of accessories, including beverage receptacles 45, mobile devices 34, trays 40, and power components 31. The cavities may be located on exterior luggage surfaces 62, such as the front face, top panel, or sidewall, and are reinforced to resist deformation.

Elastomeric inserts such as cupholder 30, etc., may be formed of rubber-like materials are designed to be press-fit into these cavities 36. These inserts offer several advantages, including secure frictional retention of stored items, easy cleaning, and reduced rattle during movement. The elastomer material may be thermoplastic elastomer (TPE), silicone rubber, or other durable and flexible polymers.

In one embodiment, the cavity 36 functions as a beverage cupholder. The corresponding cupholder insert 30 may include internal ribs or ridges 66 to conform to the outer shape of a bottle or mug 45. These ribs 66 enhance grip and minimize lateral movement. Additional versions of ribs 66 may include spring-loaded components or collapsible walls 66 to accommodate containers 45 of varying size and shape.

A notable enhancement is the inclusion of a rubber-like cupholder insert 30 that incorporates a force-fit mechanism 56. This insert features protrusions or tabs 56 around its outer perimeter that may, in some embodiments, align with holes 43 in the cavity wall 39. Upon insertion, these features 56 engage the holes 43, selectively securing the cupholder insert 30 without the need for additional fasteners.

The force-fit design also serves a sealing function. By deforming slightly under compression, the insert's edges form a tight seal against the cavity wall 39. This prevents liquids or debris from entering the cavity space or underlying luggage compartments. The sealing action is especially useful in preventing cross-contamination when used to store beverages 45.

To support mobile device 34 usage, one or more cavities 39 may include wireless charging pads or other power supply systems 31 embedded into their base 37, for example and without limitation. The charging pad, in one embodiment, is compatible with Qi wireless standards and is electrically connected to an internal power source as part of the power supply 31 within the luggage shell interior 60. This allows users to charge their devices 34 simply by placing them in the slot, cupholder or tray.

The mobile device slot 32 may be optionally covered with a hinged or removable lid 41. The lid 41 may be transparent to allow screen viewing, or opaque for security and protection from elements. The cavity of tray 40 itself may be lined with a soft-touch elastomer to prevent scratching or slipping.

Adjacent to the mobile device slot 32, two beverage receptacles 30 may be configured with its own removable insert or plug 35. When not in use, these cavities may be sealed with molded plugs 54 that include gasket rings 52 and latch mechanisms 50 to prevent ingress of contaminants and to preserve the luggage profile.

The plugs 54 may be selectively removable and may be swapped with alternate modules. For example, a cupholder insert 30 may be replaced with a charging tray 40 or storage tray 40 with cover 41. The plug 54 includes mechanical or magnetic latching features 50 to ensure secure placement and ease of removal.

A tray element 40 may be integrated into the luggage 10. The tray 40 may be recessed and surrounded by a raised edge 66 to contain items such as snacks or electronic accessories. Some trays 40 may also include embedded USB ports or wireless charging pads 31 for added functionality.

To power these modules, the luggage includes an internal energy source as part of power system 31. This may be a rechargeable lithium-ion battery housed in a protected compartment. In alternative embodiments, the luggage 10 may integrate solar panels 68 on the exterior surface or accept a plug-in AC power source.

Power may be distributed internally through shielded wiring 74 and routed to the tray, slot, or cupholder modules. These circuits are designed to be weather-resistant and vibration-tolerant. Connectors may use pogo pins or magnetic contacts to minimize wear and allow easy replacement of component, or other devices known to those of skill in the art.

Each cavity and insert module 30, 32, and 40 may incorporate RFID tags or lockable features to protect high-value items. For example, these RFID tags may be incorporated into power system 31. The RFID-lockable compartment 40 may be electronically engaged and can be used to store sensitive devices or credentials during travel.

Fastening systems 50 used for securing modules 30, 32, and 40, and plugs 54 include both mechanical snap-fits and magnetic retention, for example and without limitation. These fasteners are embedded into the cavity rim or plug perimeter and provide tactile and audible feedback to confirm secure installation.

The modular design of these systems enables application across different luggage formats. Hardshell spinner suitcases, for example, may include a front-mounted mobile tray 40 and beverage receptacles 30, while rolling duffels incorporate side-access cavities with elastomeric liners.

Backpacks may integrate vertical mobile device slots 34 and bottle holders 30 along the shoulder strap or sidewall. The reinforced tray or cavity may be supported by a semi-rigid internal frame of tray 40 that maintains cavity shape without adding excessive weight.

Specialty equipment cases, such as those used in sports or emergency response, may be fitted with reinforced compartments for gloves, tools, or medical devices. These cases benefit from the same modularity and insert system as conventional luggage.

In a combined embodiment, the front panel 12 of a suitcase 10 may include a central slot 32 for a smartphone 34, flanked on either side by circular beverage cavities 30. Each cavity 32, 34 may be fitted with a force-fit elastomeric insert 30, 32, and each may be independently sealable using a removable plug 54.

The mobile device slot 32 may include a wireless charging pad 31 and a soft, non-slip base 37. A protective flap 41 may be magnetically attached at the top edge and may be folded over to secure the phone 34 during transport.

The rear panel of the luggage 10 may include a fold-down tray 40 with recessed wells. The tray 40 with cover 41 may be used for holding small food containers, electronic accessories, or writing tools. A wireless charging pad of system 31 may also be included.

All cavities, slots, and trays follow a standardized dimensioning protocol to ensure cross-compatibility with insert modules. This enables users to customize their travel gear across product lines without requiring unique accessories for each format.

The foam-sealed construction of the cavities and trays ensures that internal power modules and connectors are insulated from vibration and minor impacts. The tray and slot modules may also include shock-absorbing bases to protect fragile electronic devices.

Overall, the combination of modular receptacles, charging features, and rugged construction transforms traditional luggage into an adaptable, user-centered system. Whether used in a rolling duffel, backpack, or spinner case, these features deliver consistent functionality, comfort, and innovation for modern travel.

In other embodiments, the luggage system 10 of the present disclosure includes a front portion 12 and a rear portion 14 that together define an enclosed interior volume 60 for the containment of personal items. These portions 12, 14 may be hingedly or removably joined using zippers, latches, or clamshell-style couplings 16. The separation allows for full access to the interior 60 and facilitates efficient packing and unpacking.

One or both portions 12, 14 of the luggage 10 include pre-molded cavities 30, 32, and 40 configured to receive modular inserts. These cavities are precisely dimensioned to host a variety of accessories, including beverage receptacles 30, mobile device holders 32, trays 40, and power components 31. The cavities may be located on exterior surfaces of the luggage 10, such as the front face, top panel, or sidewall, and are reinforced to resist deformation.

Elastomeric inserts 30, 32, and 40 may be formed of rubber-like materials are designed to be press-fit into these cavities. These inserts offer several advantages, including secure frictional retention of stored items, easy cleaning, and reduced rattle during movement. The elastomer material may be thermoplastic elastomer (TPE), silicone rubber, or other durable and flexible polymers.

In one embodiment, the cavity functions as a beverage cupholder 30. The corresponding insert includes internal ribs or ridges 66 to conform to the outer shape of a bottle or mug 45. These ribs enhance grip and minimize lateral movement. Additional versions may include spring-loaded components or collapsible walls to accommodate containers of varying size and shape.

A notable enhancement is the inclusion of a rubber-like cupholder insert 30 that incorporates a force-fit mechanism 35. This insert features protrusions or tabs around its outer perimeter that align with holes 43 in the cavity bottom 37 or wall 39. Upon insertion, these features engage the holes, securing the insert without the need for additional fasteners.

The force-fit design also serves a sealing function. By deforming slightly under compression, the insert's edges form a tight seal against the cavity wall. This prevents liquids or debris from entering the cavity space or underlying luggage compartments. The sealing action is especially useful in preventing cross-contamination when used to store beverages.

To support mobile device usage, one or more cavities 30, 32, and 40 may include wireless charging pads embedded into their base. The charging pad is compatible with Qi wireless standards and may be electrically connected to an internal power source within the luggage shell. This allows users to charge their devices simply by placing them in the slot.

The mobile device slot 32 or tray 40 may be optionally covered with a hinged or removable lid 41. The lid 41 may be transparent to allow screen viewing, or opaque for security and protection from elements. The cavity itself may be lined with a soft-touch elastomer to prevent scratching or slipping.

Adjacent to the mobile device slot, two beverage receptacles 30 may be formed, each with its own removable insert or plug 54. When not in use, these cavities are sealed with molded plugs 54 that include gasket rings 52 and latch mechanisms 50 to prevent ingress of contaminants and to preserve the luggage profile.

The plugs 54 may be selectively removable and may be swapped with alternate modules. For example, a cupholder insert 30 can be replaced with a tray 40 or a slot 32. The plug system includes mechanical or magnetic latching features 50 to ensure secure placement and ease of removal.

A tray 40 may be integrated into the luggage 10 surfaces. The tray 40 may be recessed and surrounded by a raised edge 66 to contain items such as snacks or electronic accessories. Some trays also include embedded USB ports or wireless charging pads 31 for added functionality.

To power these modules, the luggage 10 may include an internal energy source 31. This may be a rechargeable lithium-ion battery housed in a protected compartment. In alternative embodiments, the luggage 10 may integrate solar panels 68 on the exterior surface or accept a plug-in power source.

Power may be distributed internally through shielded wiring 74 and routed to the tray, slot, or receptacle modules 30, 32, and 40. These circuits 74 are designed to be weather-resistant and vibration-tolerant. Connectors may use pogo pins or magnetic contacts to minimize wear and allow easy replacement of components.

Each cavity and insert module may incorporate RFID tags or lockable features to protect high-value items, such as with the power system 31. The RFID-lockable compartment or tray 40 may be electronically engaged with the lid 41 and can be used to store sensitive devices or credentials during travel.

Fastening systems used for securing modules and plugs include both mechanical snap-fits and magnetic retention. These fasteners are embedded into the cavity rim or plug perimeter and provide tactile and audible feedback to confirm secure installation.

The modular design of these systems enables application across different luggage formats. Hardshell spinner suitcases, for example, may include a front-mounted mobile tray and beverage receptacles, while rolling duffels incorporate side-access cavities with elastomeric liners.

Backpacks may integrate vertical mobile device slots and bottle holders along the shoulder strap or sidewall. The reinforced tray or cavity is supported by a semi-rigid internal frame that maintains cavity shape without adding excessive weight.

Specialty equipment cases, such as those used in sports or emergency response, may be fitted with reinforced compartments for gloves, tools, or medical devices. These cases benefit from the same modularity and insert system as conventional luggage.

In a combined embodiment, the front panel of a suitcase includes a central slot for a smartphone, flanked on either side by circular beverage cavities. Each cavity is fitted with a force-fit elastomeric insert, and each slot is independently sealable using a removable plug.

The mobile device slot includes a wireless charging pad and a soft, non-slip base. A protective flap is magnetically attached at the top edge and may be folded over to secure the phone during transport.

Adjacent beverage receptacles may accommodate, for example, 12-20 oz containers and include a drainage port at the bottom edge. This port is automatically sealed by the elastomeric insert when in place and may be opened for cleaning.

The rear panel of the luggage may include a fold-down tray with multiple recessed wells. These may be used for holding small food containers, electronic accessories, or writing tools. At least one of the wells includes an embedded charging pad.

In embodiments, the cavities, slots, and trays may follow a standardized dimensioning protocol to ensure cross-compatibility with insert modules. This enables users to customize their travel gear across product lines without requiring unique accessories for each format.

The foam 76 construction of the cavities and trays ensures that internal power modules and connectors are insulated from vibration and minor impacts. The tray and slot modules may also include shock-absorbing bases to protect fragile electronic devices.

Overall, the combination of modular receptacles, charging features, and rugged construction transforms traditional luggage into an adaptable, user-centered system. Whether used in a rolling duffel, backpack, or spinner case, these features deliver consistent functionality, comfort, and innovation for modern travel.

The present disclosure has been described with reference to exemplary features and configurations. However, it is understood that the embodiments described herein are merely illustrative and not limiting of the scope of the invention. Various changes in form and detail may be made without departing from the scope of the invention, as defined in the appended claims.

All references cited herein are incorporated by reference in their entirety. The words “comprising,” “including,” and “having” when used in the claims are intended to be open-ended and mean “including but not limited to.” The singular forms “a,” “an,” and “the” include plural referents unless the context clearly dictates otherwise.

1. A luggage system comprising:
an exterior shell;
at least one cavity formed in the exterior shell;
a selectively removable elastomeric insert positioned within the cavity;
wherein the insert is formed of a rubber-like material and includes a force-fit mechanism configured to engage a corresponding feature of the cavity to retain the insert in position and form a seal against ingress of contaminants.

2. The luggage system of claim 1, wherein the cavity is shaped to receive a beverage container, and the elastomeric insert includes internal ribs or a flexible flange configured to stabilize the beverage container.

3. The luggage system of claim 1, wherein the cavity is shaped to receive a mobile electronic device, and the insert comprises an embedded wireless charging coil electrically coupled to a power supply within the luggage.

4. The luggage system of claim 3, further comprising a transparent or hinged cover configured to protect the mobile electronic device while allowing viewing of the screen.

5. The luggage system of claim 1, wherein the force-fit mechanism comprises compressible lobes, ridges, or tabs that deform into corresponding holes or grooves formed in the cavity wall.

6. The luggage system of claim 1, further comprising a removable plug module configured to seal the cavity when the insert is not in use.

7. The luggage system of claim 6, wherein the plug module includes a compressive gasket and a latching mechanism selected from a twist-lock, snap-fit, or magnetic latch.

8. The luggage system of claim 6, wherein the plug module includes a visual indicator to confirm proper sealing.

9. A luggage system comprising:
an exterior shell;
a mobile device slot formed in the shell;
a Qi-compatible wireless charging coil embedded in the slot;
a rechargeable battery disposed within the shell and electrically coupled to the charging coil;
wherein the slot includes an elastomeric lining and a cover configured to protect a device during transport.

10. The luggage system of claim 9, wherein the cover is transparent and hinged or magnetically attached.

11. The luggage system of claim 9, further comprising an LED indicator that provides charging status.

12. The luggage system of claim 9, wherein the slot includes alignment guides or detents for positioning the mobile device.

13. The luggage system of claim 9, further comprising a solar panel mounted on the exterior shell, electrically coupled to the rechargeable battery.

14. A luggage system comprising:
a set of standardized cavities formed in an exterior shell;
a plurality of interchangeable plug modules configured to mate with the standardized cavities;
each plug module including a sealing element and a latching mechanism;
wherein the plug modules differ in geometry or function and are replaceable across different luggage formats.

15. The luggage system of claim 14, wherein at least one plug module includes an RFID tag or embedded sensor for tracking or verification.

16. The luggage system of claim 14, wherein the latching mechanism comprises a twist-lock, snap-fit, or magnetic fastener.

17. The luggage system of claim 14, wherein the plug module includes a drainage seal or environmental barrier.

18. The luggage system of claim 14, wherein the plug module is removable without tools via a molded grip or tab.

19. The luggage system of claim 14, wherein at least one standardized cavity includes a recessed tray for food or electronics and an embedded charging interface.

20. The luggage system of claim 14, wherein the system includes accessory kits containing plug modules and cavity inserts for user customization.
